(19) United States
(12) Patent Application Publication
(10) Pub. No.: US 2006/0273085 A1
(43) Pub. Date: Dec. 7, 2006

(54) JOINT FOR CONNECTING WORKPIECES

(76) Inventor: Daniel A. Casto, Hendersonville, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/383,968

(22) Filed: May 18, 2006

Related U.S. Application Data
(60) Provisional application No. 60/682,100, filed on May 18, 2005.

(51) Int. Cl. F16D 1/00

(52) U.S. Cl. 220/62; 409/132; 403/381

(57) ABSTRACT

A joint for securing two workpieces together. The joint includes a projection and a complimentary slot for receiving and securing the projection therein. The projection includes spaced-apart convex sidewalls extending outwardly from a first workpiece, and an end wall connecting outer ends of the sidewalls. The slot is formed in a second workpiece, and includes an opening for receiving the projection therethrough and a pair of spaced-apart concave sidewalls which define lateral boundaries of the slot.

This application claims the benefit of Provisional Application No. 60/682,100 filed on May 18, 2005.

### TECHNICAL FIELD AND BACKGROUND OF THE INVENTION

The present invention relates to a joint for securing workpieces together. In particular, the invention relates to a joint for securing workpieces together without the use of a clamp, fastener, or adhesive.

Joints for securing workpieces together take many forms. Some of the typical joints used are dovetail joints, FIG. 1, and dado joints, FIG. 2. Dovetail joints may be formed by cutting a plurality of slots into adjacent workpieces to form outwardly projecting fingers, as shown in FIG. 1, or by cutting a single slot on one workpiece and a single outwardly projecting finger on another. One disadvantage of the dovetail joint is that its application can be limited due to the method of assembling the joint. To assemble the joint, the outwardly projecting finger must be slid into the complimentary slot. Thus, a specific sequence must be followed when using dovetail joints to assemble a product, such as a cabinet.

For example, a cabinet 10, as shown in FIGS. 3, 4, and 7, includes a back wall 11, a pair of opposing sidewalls 12 and 13, a face frame 14, and a bottom 15. The cabinet also includes a nail rail 16, a back stretcher 17, and a front stretcher 18. After cutting the required dovetail joints, the cabinet is assembled by first attaching the opposing sidewalls 12 and 13 to the bottom 15. This is done by sliding the outwardly projecting fingers positioned on opposing ends of the bottom 15 into the corresponding slots positioned on each of the sidewalls 12 and 13. Next the outwardly projecting fingers of the front stretcher 18 and back stretcher 17 are slid into corresponding slots of the sidewalls 12 and 13. Then the outwardly projecting fingers of the nail rail 16 are slid into corresponding slots of the sidewalls 12 and 13, and the back wall 11 is attached to the nail rail 16, sidewalls 12 and 13, and bottom 15. Finally the face frame 14 is installed by sliding the slots in the face frame 14 over the outwardly projecting fingers of the sidewalls 12 and 13.

In addition to the requirement of following a specific sequence to assemble the cabinet 10, additional disadvantages become apparent. For example, the face frame 14 can only be attached at two points, i.e. the sidewalls 12 and 13, due to the nature of the dovetail joint. Thus, an adhesive or fastener must be used to attach the face frame 14 to the front stretcher 18 and the bottom 15. This is also true of the back stretcher 17 and the nail rail 16.

Dado joints are typically used when it is desired to support one workpiece within a slot of another workpiece. For example, dado joints may be used in making bookshelves. When making book shelves, a slot is cut on the inside surface of opposing vertical sidewalls. A shelving member is then placed between the vertical sidewalls with the opposing ends of the shelving member positioned in the slots. This type of joint is advantageous in this scenario because the slots provide a support for the shelving member to rest upon. Dado joints can also be used in cabinet making. For example, in the cabinet 10 described above, a dado joint could be used to attach the face frame 14 to the front stretcher 18 and the bottom 15. However, clamps or fasteners and an adhesive would still be needed to secure the face frame 14 to the front stretcher 18 and bottom 15.

Accordingly, there is a need for a joint which minimizes the use of tools, fasteners, and adhesives and increases assembly time.

### SUMMARY OF THE INVENTION

Therefore, it is an object of the invention to provide a joint that increases productivity by providing a joint that does not require an adhesive to secure the joint together, thereby eliminating adhesive curing time.

It is another object of the invention to provide a joint that is self-securing and eliminates the step of clamping the joint together.

It is another object of the invention to provide a joint that minimizes the use of mechanical fasteners.

It is another object of the invention to provide a joint that allows manufacturers to ship unassembled products that may be assembled elsewhere without tools.

It is another object of the invention to provide a joint that can be used for applying a face frame to a cabinet without an adhesive, clamp, or fastener.

It is another object of the invention to provide a cutting apparatus for forming a joint.

It is another object of the invention to provide a method for assembling a cabinet.

These and other objects of the present invention are achieved in the preferred embodiments disclosed below by providing a joint for securing two workpieces together including a projection and a complimentary slot. The projection including spaced-apart convex sidewalls extending outwardly from a first workpiece, and an end wall connecting outer ends of the sidewalls. The complimentary slot is formed in a second workpiece for receiving and securing the projection therein and includes an opening for receiving the projection therethrough and a pair of spaced-apart concave sidewalls which define lateral boundaries of the slot.

According to another preferred embodiment of the invention, the opening has a width which is smaller than a maximum width of the projection.

According to another preferred embodiment of the invention, the sidewalls of at least one of the projection and the slot are adapted to deflect to allow the projection to pass through the opening.

According to another preferred embodiment of the invention, when positioned in the slot the sidewalls of the projection reside in mating engagement with the sidewalls of the slot to prevent the joint from separating.

According to another preferred embodiment of the invention, each of the sidewalls of the projection includes a first sidewall segment with proximate and distal ends, the distal end being further away from a centerline of the projection than the proximate end; and a second sidewall segment extending outwardly from the distal end of the first sidewall segment and angled towards the centerline of the projection.

According to another preferred embodiment of the invention, each of the sidewalls of the slot includes a first sidewall segment extending inwardly from a proximate end at the opening to a distal end, the distal end being further away from a centerline of the slot than the proximate end; and a second sidewall segment extending inwardly from the distal end of the first sidewall segment and angled towards the centerline of the slot.

According to another preferred embodiment of the invention, the projection and slot are adapted to be snapped together by forcing the projection through the opening.

According to another preferred embodiment of the invention, a cutting apparatus includes a shank for being received by a rotary tool, and a cutting head disposed at an end of the shank, the cutting head having a cutting edge with a cross-sectional profile defining spaced-apart sidewalls. Each of the sidewalls includes a first sidewall segment with proximate and distal ends, the distal end being further away from a centerline of the cuffing head than the proximate end; and a second sidewall segment extending outwardly from the distal end of the first sidewall segment and angled towards the centerline of the cutting head.

According to another preferred embodiment of the invention, and further including an end wall positioned substantially perpendicular to the centerline of the cutting head and connecting outer ends of the second sidewall segments.

According to another preferred embodiment of the invention, a cutting apparatus includes a shank for being received by a rotary tool, and a cutting head disposed at an end of the shank. The cutting head has a cross-sectional profile defining a shoulder, an end wall, and spaced-apart V-shaped sidewalls extending between the shoulder and end wall.

According to another preferred embodiment of the invention, each of the sidewalls of the cuffing head includes a first sidewall segment extending outwardly from a proximate end at the shoulder to a distal end, the distal end being closer to a centerline of the cutting head than the proximate end; and a second sidewall segment extending outwardly from the distal end of the first sidewall segment and angled away from the centerline of the cutting head.

According to another preferred embodiment of the invention, the shoulder is substantially perpendicular to a centerline of the cutting head.

According to another preferred embodiment of the invention, the end is substantially perpendicular to a centerline of the cutting head.

According to another preferred embodiment of the invention, a method of forming a joint includes the steps of providing first and second workpieces, forming a projection on the first workpiece, and forming a slot in the second workpiece. The projection includes spaced-apart convex sidewalls extending outwardly from the first workpiece, and an end wall connecting outer ends of the sidewalls. The slot includes an opening for receiving the projection therethrough, and a pair of spaced-apart concave sidewalls which define lateral boundaries of the slot.

According to another preferred embodiment of the invention, the step of forming the projection includes the steps of cutting a first side of an end of the first workpiece, and cutting an opposing second side of the end of the first workpiece.

According to another preferred embodiment of the invention, and further including the step of securing the projection within the slot.

According to another preferred embodiment of the invention, a method of securing two workpieces together including the steps of providing a first workpiece having an outwardly extending projection having spaced-apart convex sidewalls extending outwardly from a first workpiece, and an end wall connecting outer ends of the sidewalls; providing a second workpiece having a complimentary slot formed therein for receiving and securing the projection including an opening for receiving the projection therethrough, and a pair of spaced-apart concave sidewalls which define lateral boundaries of the slot. The method further including the steps of positioning the projection in alignment with the opening, and forcing the projection past the opening and into the slot. The sidewalls of the projection and the sidewalls of the slot being in mating engagement with each other to prevent the projection from withdrawing out of the slot.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows a dovetail joint;

FIG. 2 shows a dado joint;

FIG. 3 is a perspective view of a cabinet assembly using the joint of FIG. 1;

FIG. 4 is a front view of the cabinet assembly of FIG. 3;

FIG. 5 is an enlarged view of a joint between a front stretcher and a sidewall of the cabinet assembly of FIG. 3;

FIG. 6 is an enlarged view of a joint between a bottom and a sidewall of the cabinet assembly of FIG. 3;

FIG. 7 is a top view of the cabinet assembly of FIG. 3;

FIG. 8 is an enlarged view of a joint between a nail rail and a sidewall of the cabinet assembly of FIG. 3;

FIG. 9 is an enlarged view of a joint between a face frame and a sidewall of the cabinet assembly of FIG. 3;

FIG. 10 shows an assembled joint according to an embodiment of the invention;

FIG. 11 shows a projection of the joint of FIG. 10;

FIG. 12 shows another projection of the joint of FIG. 10;

FIG. 13 shows a slot of the joint of FIG. 10;

FIG. 14 shows a vertical cross-section of a cutting apparatus for forming the slot of FIG. 13;

FIG. 15 shows a vertical cross-section of a cutting apparatus for forming the projection of FIG. 11;

FIG. 16 is a perspective view of a cabinet assembly;

FIG. 17 is a perspective view of the cabinet assembly of FIG. 16 using the joints of FIG. 1 and FIG. 10;

FIG. 18 is an enlarged view of a joint between a bottom and a sidewall of the cabinet assembly of FIG. 16;

FIG. 19 is a side view of the cabinet assembly of FIG. 16;

FIG. 20 is an enlarged view of a joint between a back stretcher and a nail rail of the cabinet assembly of FIG. 16; and

FIG. 21 is an enlarged view of a joint between a face frame and a front stretcher of the cabinet assembly of FIG. 16.

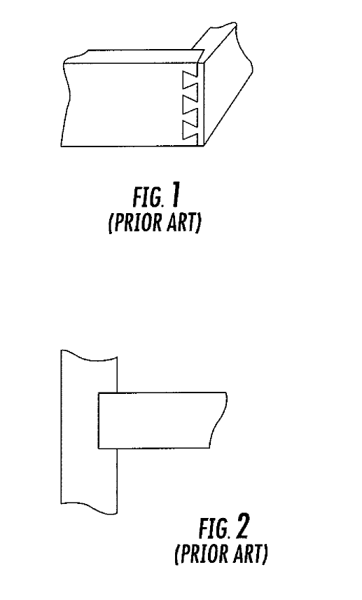

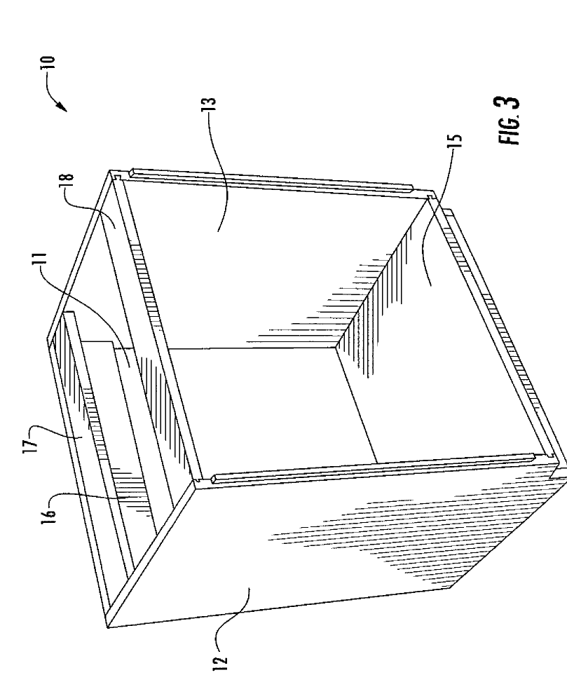

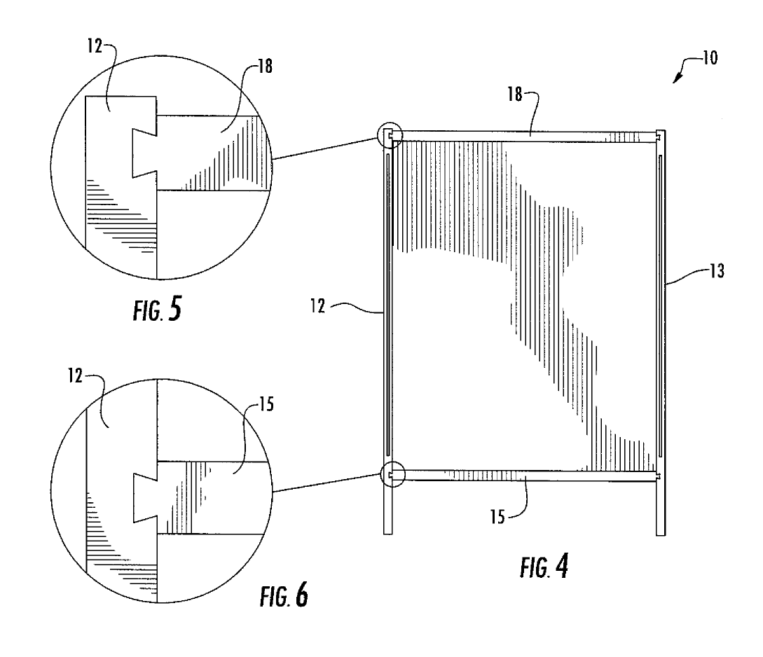

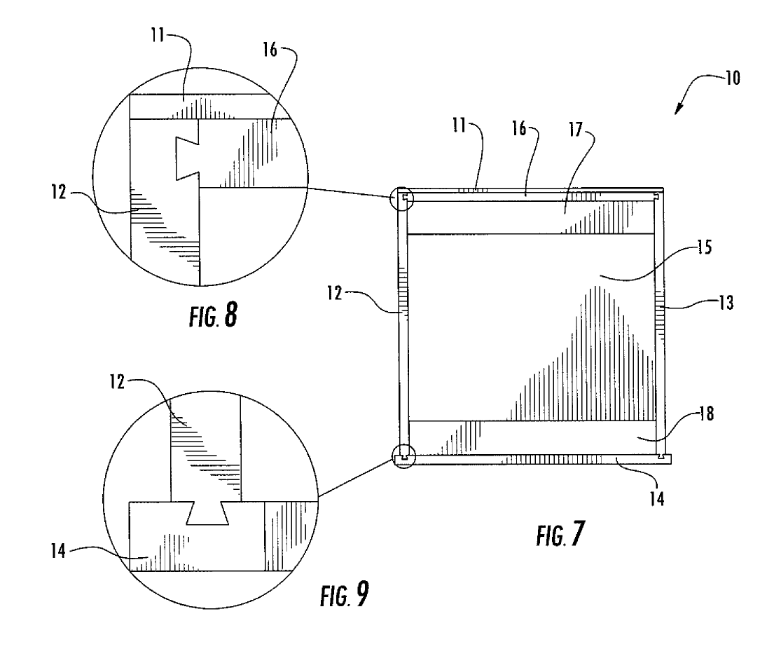

### DESCRIPTION OF THE PREFERRED EMBODIMENT AND BEST MODE

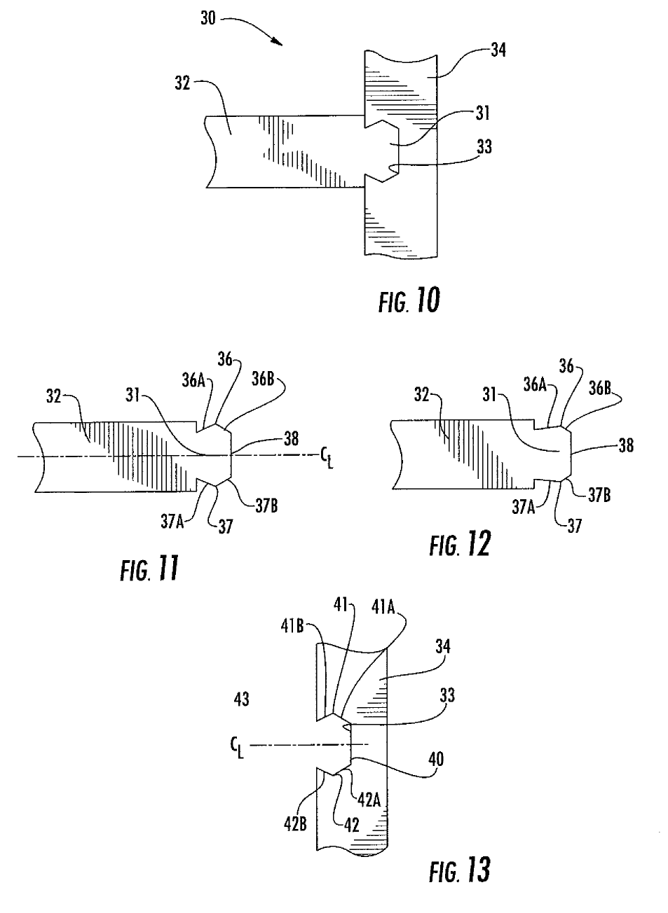

Referring now specifically to the drawings, a joint for securing workpieces together according to an embodiment of the invention is illustrated in FIG. 10 and shown generally at reference numeral 30. The joint 30 includes an outwardly extending projection 31 positioned on a first workpiece 32 and a complementary slot 33 for receiving the projection 31 on a second workpiece 34.

As shown in FIG. 11, the projection 31 includes a pair of generally convex opposing sidewalls 36 and 37 and an end wall 38. The sidewalls 36 and 37 each include two angled sidewall segments 36A, 36B and 37A, 37B. As illustrated, the sidewall segments 36A and 37A project from the first workpiece 32 at an angle outwardly away from a centerline of the workpiece 32, and the sidewall segments 36B and 37B extend from the distal ends of the sidewall segments 36A and 37A to the end wall 38 at an angle inwardly towards the centerline of the workpiece 32, thereby forming the generally convex profile of the sidewalls 36 and 37.

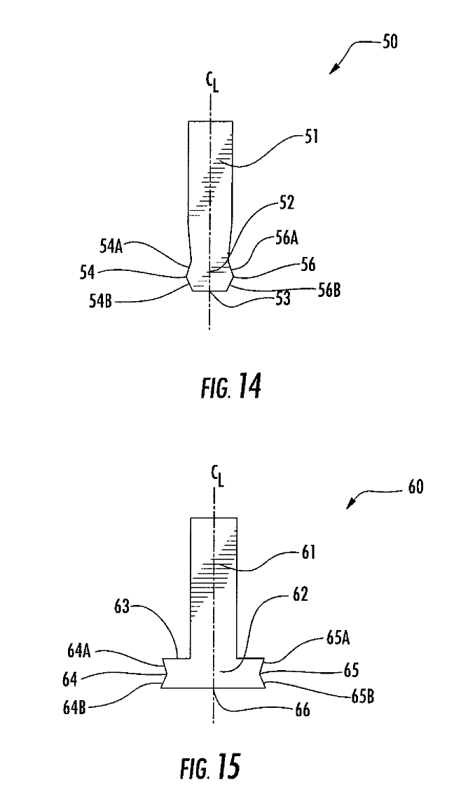

The angle of the sidewall segments 36A, 36B and 37A, 37B may be varied according to the density of the materials being used. For example, in FIG. 12, the angle of sidewall segments 36A and 37A may be decreased, thereby increasing the angle of sidewall segments 36B and 37B. Also, the sidewall segments may be curved to form a smooth curved sidewall.

As shown in FIG. 13, the slot 33 includes an end wall 40, a pair of generally concave sidewalls 41 and 42, and an opening 43. The shape and dimensions of the slot 33 are substantially identical to the size and shape of the projection 31 to allow the slot 33 to receive and secure the projection 31 therein, thereby securing the first and second workpieces 32 and 34 together. The sidewalls 41 and 42 each include two angled sidewall segments 41A, 41B and 42A, 42B. As illustrated, the sidewall segments 41A and 42A project from the end wall 40 at an angle outwardly away from a centerline of the slot 33, and the sidewall segments 41B and 42B project from the distal ends of the sidewall segments 41A and 42A to the opening 43 at an angle inwardly towards the centerline of the slot 33, thereby forming the generally concave profile of the sidewalls 41 and 42. The opening 43 is dimensioned to allow the projection 31 to be forced or snapped into the slot 33 while preventing the projection 31 from disengaging the slot 33 inadvertently.

The first and second workpieces 32 and 34 are secured together by forcing the projection 31 through the opening 43 until the projection 31 is positioned within the slot 33. This is done by placing the end wall 38 of the projection 31 in the opening 43 and then forcing the projection 31 into the slot 33. The angle of the sidewall segments 36B and 37B provide a taper to aid in forcing the projection 31 past the opening 43 and into the slot 33. As the projection 31 is forced through the opening 43, the sidewalls 36 and 37 compress to allow the projection 31 to squeeze through the opening 43. Once the projection 31 is positioned within the slot 33, the sidewalls 36 and 37 decompress and engage sidewalls 41 and 42. The sidewall segments 36A and 37A of the projection 31 engage the sidewall segments 41B and 42B of the slot 33 to prevent the joint 30 from separating, while at the same time providing a taper to aid in the separation of the joint 30 when desired.

Referring to FIG. 14, the slot 33 is formed by removing material from the workpiece 34 using a slot cutting apparatus 50. The apparatus 50 may be used in any known router. The apparatus 50 includes a shank 51 for being inserted in and secured to a router and a cutting head 52 for cutting the slot 33. The cutting head 52 has an end 53 generally convex opposing sidewalls 54 and 56, giving the cutting head 52 a profile substantially identical to the projection 31. The sidewalls 54 and 56 each include two sidewall segments 54A, 54B and 56A, 56B. As illustrated, the sidewall segments 54A and 56A extend from the shank 51 at an angle outwardly away from a centerline of the apparatus 50, and the sidewall segments 54B and 56B project from the distal ends of the sidewall segments 54A and 56A to the end 53 at an angle inwardly towards the centerline of the apparatus 50, thereby forming the generally convex profile of the sidewalls 54 and 56. The apparatus 50 is attached to the router and spun at a high rate of speed, enabling the apparatus 50 to remove material from the workpiece 34, thereby creating the slot 33.

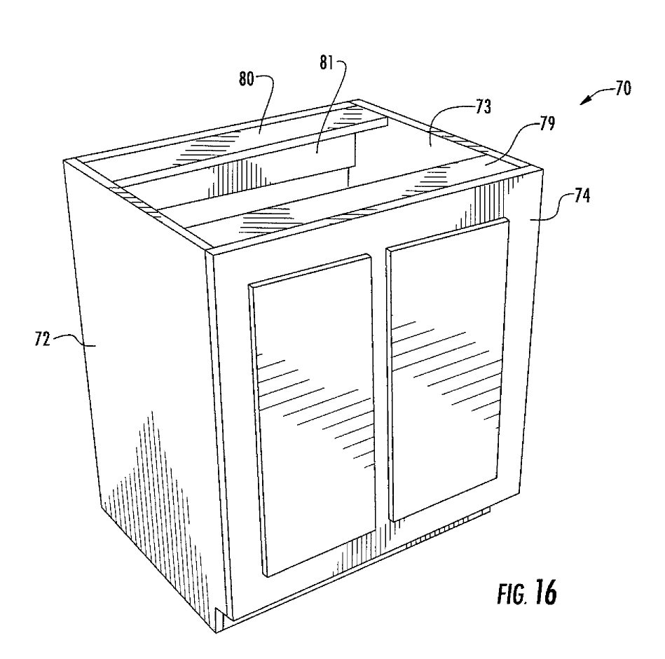

Referring to FIG. 15, the projection 31 is formed by removing material from opposing edges on an end of the workpiece 32 using an edge cutting apparatus 60. The apparatus 60 may be used in any known router. Like apparatus 50, apparatus 60 includes a shank 61 for being inserted in and secured to a router and a cutting head 62. The cutting head 62 includes a shoulder 63, two opposed, generally concave sidewalls 64 and 65, and an end 66. The sidewalls 64 and 65 each include two sidewall segments 64A, 64B and 65A, 65B. As illustrated, the cutting head 62 has a larger diameter than the shank 61. Sidewall segments 64A and 65A extend from the shoulder 63 at an angle inwardly towards a centerline of the apparatus 60, and sidewall segments 64B and 65B extend from the distal ends of the sidewall segments 64A and 65A at an angle outwardly away from the centerline of the apparatus 60 to the end 66. The apparatus 60 is attached to the router and spun at a high rate of speed, enabling the apparatus 60 to remove material from an edge of workpiece 32.

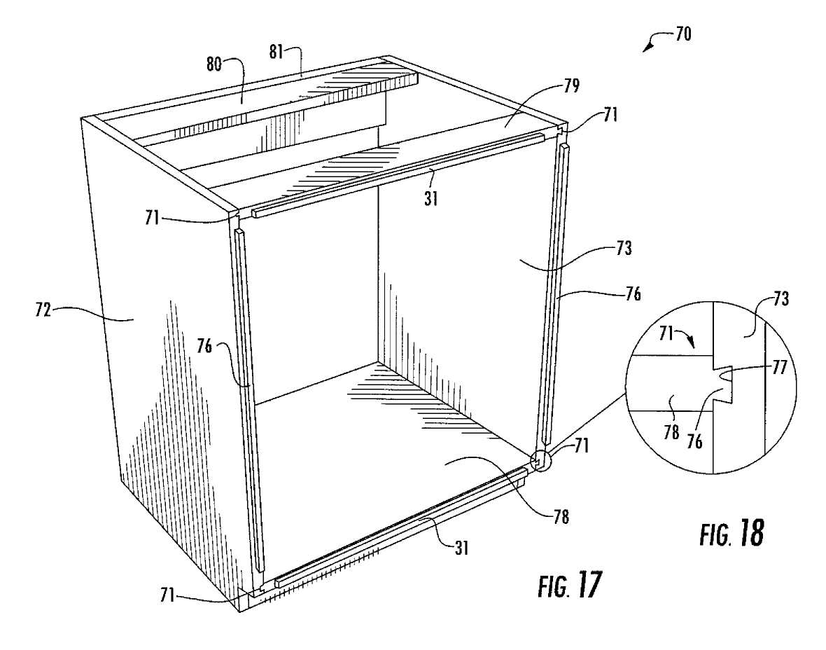

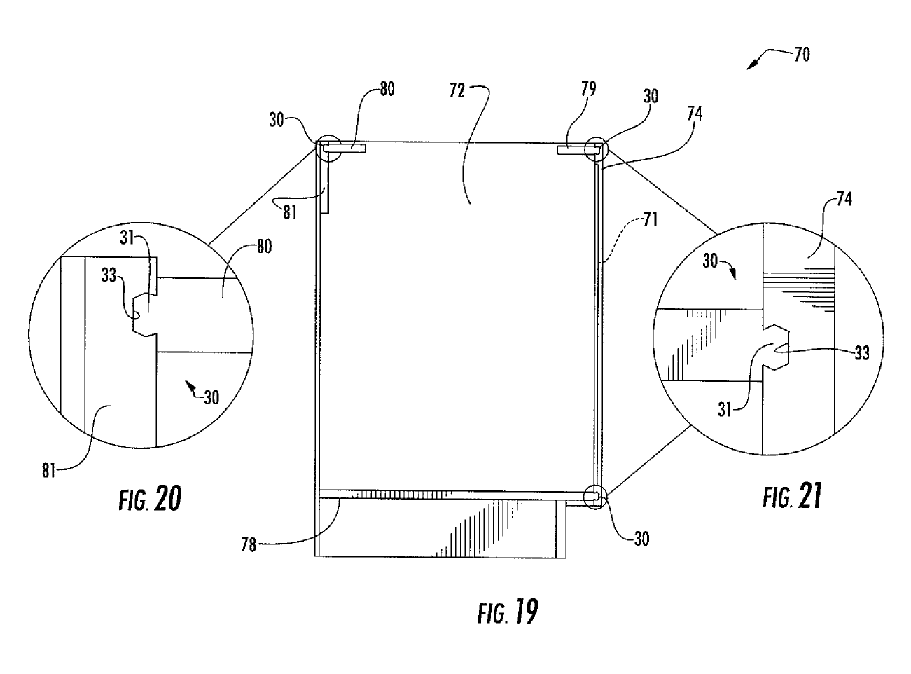

The joint 30 is particularly well suited for use in cabinet making due to its ability to secure workpieces together without the use of clamps, fasteners, or adhesives. For example, a cabinet 70, as shown in FIGS. 16-21, is formed using the joint 30 in combination with dovetail joints 71. The cabinet 70 is assembled by first cutting all of the joints required for assembling the cabinet 70. The joints 30 are cut by the cutting apparatuses 50 and 60 described above. Next, sidewalls 72 and 73 are attached to a face frame 74. This is done by sliding outwardly projecting fingers 76 of the dovetail joints 71 on the sidewalls 72 and 73 into slots 77 of the dovetail joints 71 on the face frame 74. Next a bottom 78 is attached to the sidewalls 72 and 73 by sliding the outwardly projecting fingers 76 on the bottom 78 into the slots 77 on the sidewalls 72 and 73. When the bottom 78 abuts against the face frame 74, the joint 30 between the face frame 74 and bottom 78 is snapped together. Then the outwardly projecting fingers 76 of a front stretcher 79 are slid into the slots 77 on the sidewalls 72 and 73 until the front stretcher 79 abuts against the face frame 74. The front stretcher 79 and face frame 74 are snapped together using the joint 30. The outwardly projecting fingers 76 of a back stretcher 80 is then slid into the slots 77 on the sidewalls 72 and 73 to a point about 2 inches past a back end of the sidewalls 72 and 73. Next the outwardly projecting fingers 76 of a nail rail 81 are slid into the slots 77 on the sidewalls 72 and 73. Finally, the back stretcher 80 is slid towards the nail rail 81, allowing the nail rail 81 and back stretcher 80 to be snapped together using the joint 30.

As can be seen from the assembly of the cabinet 70, the joint 30 allows the face frame 74 to be attached along four edges instead of two without using adhesives or fasteners. This is also true of the back stretcher 80 and nail rail 81. Thus, a stronger cabinet can be manufactured in a more efficient manner.

The cabinet 70 may also be formed using only the joint 30. By replacing the dovetail joints 71 with the joint 30, the cabinet 70 can be snapped together, providing greater flexibility in the assembly of the cabinet 70. For example, the sidewalls 72 and 73 can be connected to the bottom 78, front stretcher 79, and back stretcher 80 by snapping the pieces together. The nail rail 81 can then be connected to the back stretcher 80 and the face frame 74 can be connected to the front stretcher 79, sidewalls 72 and 73, and bottom 78.

Because the joint 30 provides flexibility in assembling the cabinet 70, the cabinet 70 could also be assembled using other sequences. For example, the cabinet 70 could be assembled using the sequence described above in reference to the combination of the dovetail joints 71 and the joint 30. Other changes such as installing the nail rail 81 to the back stretcher 80 before installing the back stretcher 80 could also be made.

A joint for connecting workpieces is described above. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. A joint for securing two workpieces together, comprising:
(a) a projection, comprising:
(i) spaced-apart convex sidewalls extending outwardly from a first workpiece; and
(ii) an end wall connecting outer ends of the sidewalls;
(b) a complimentary slot formed in a second workpiece for receiving and securing the projection therein, comprising:
(i) an opening for receiving the projection therethrough; and
(ii) a pair of spaced-apart concave sidewalls which define lateral boundaries of the slot.

2. The joint according to claim 1, wherein the opening has a width which is smaller than a maximum width of the projection.

3. The joint according to claim 1, wherein the sidewalls of at least one of the projection and the slot are adapted to deflect to allow the projection to pass through the opening.

4. The joint according to claim 1, wherein when positioned in the slot the sidewalls of the projection reside in mating engagement with the sidewalls of the slot to prevent the joint from separating.

5. The joint according to claim 1, wherein each of the sidewalls of the projection includes:
(a) a first sidewall segment with proximate and distal ends, the distal end being further away from a centerline of the projection than the proximate end; and
(b) a second sidewall segment extending outwardly from the distal end of the first sidewall segment and angled towards the centerline of the projection.

6. The joint according to claim 1, wherein each of the sidewalls of the slot includes:
(a) a first sidewall segment extending inwardly from a proximate end at the opening to a distal end, the distal end being further away from a centerline of the slot than the proximate end; and
(b) a second sidewall segment extending inwardly from the distal end of the first sidewall segment and angled towards the centerline of the slot.

7. The joint according to claim 1, wherein the projection and slot are adapted to be snapped together by forcing the projection through the opening.

8. A cutting apparatus, comprising:
(a) a shank for being received by a rotary tool; and
(b) a cutting head disposed at an end of the shank, the cutting head having a cutting edge with a cross-sectional profile defining spaced-apart sidewalls, each of the sidewalls comprising:
(i) a first sidewall segment with proximate and distal ends, the distal end being further away from a centerline of the cutting head than the proximate end; and
(ii) a second sidewall segment extending outwardly from the distal end of the first sidewall segment and angled towards the centerline of the cutting head.

9. The cutting apparatus according to claim 8, and further including an end wall positioned substantially perpendicular to the centerline of the cutting head and connecting outer ends of the second sidewall segments.

10. A cutting apparatus, comprising:
(a) a shank for being received by a rotary tool; and
(b) a cutting head disposed at an end of the shank, the cutting head having a cross-sectional profile defining:
(i) a shoulder;
(ii) an end wall; and
(iii) spaced-apart V-shaped sidewalls extending between the shoulder and end wall.

11. The cutting apparatus according to claim 10, wherein each of the sidewalls of the cutting head includes:
(a) a first sidewall segment extending outwardly from a proximate end at the shoulder to a distal end, the distal end being closer to a centerline of the cutting head than the proximate end; and
(b) a second sidewall segment extending outwardly from the distal end of the first sidewall segment and angled away from the centerline of the cutting head.

12. The cutting apparatus according to claim 10, wherein the shoulder is substantially perpendicular to a centerline of the cutting head.

13. The cutting apparatus according to claim 10, wherein the end is substantially perpendicular to a centerline of the cutting head.

14. A method of forming a joint, comprising the steps of:
(a) providing first and second workpieces;
(b) forming a projection on the first workpiece, comprising:
(i) spaced-apart convex sidewalls extending outwardly from the first workpiece; and
(ii) an end wall connecting outer ends of the sidewalls;
(c) forming a slot in the second workpiece, comprising:
(i) an opening for receiving the projection therethrough; and
(ii) a pair of spaced-apart concave sidewalls which define lateral boundaries of the slot.

15. The method according to claim 14, wherein the step of forming the projection includes the step of:
(a) cuffing a first side of an end of the first workpiece; and
(b) cutting an opposing second side of the end of the first workpiece.

16. The method according to claim 14, and further including the step of securing the projection within the slot.

17. A method of securing two workpieces together, comprising the steps of:
(a) providing a first workpiece having an outwardly extending projection, the projection comprising:
(i) spaced-apart convex sidewalls extending outwardly from a first workpiece; and
(ii) an end wall connecting outer ends of the sidewalls;
(b) providing a second workpiece having a complimentary slot formed therein for receiving and securing the projection, the slot comprising:
(i) an opening for receiving the projection therethrough; and
(ii) a pair of spaced-apart concave sidewalls which define lateral boundaries of the slot.
(c) positioning the projection in alignment with the opening; and
(d) forcing the projection past the opening and into the slot, wherein the sidewalls of the projection and the sidewalls of the slot are in mating engagement with each other to prevent the projection from withdrawing out of the slot.

18. The method according to claim 17, wherein the opening has a width which is smaller than a maximum width of the projection.

19. The method according to claim 17, wherein the sidewalls of at least one of the projection and the slot are adapted to deflect to allow the projection to pass through the opening.
